(19) United States
(12) Patent Application Publication
(10) Pub. No.: US 2004/0011594 A1
(43) Pub. Date: Jan. 22, 2004

(54) Overhead assembly for vehicle lift

(76) Inventor: Jason Stewart, Madison, IN (US)

Correspondence Address: FROST BROWN TODD, LLC, 2200 PNC CENTER, 201 E. FIFTH STREET, CINCINNATI, OH, 45202, US

(21) Appl. No.: 10/173,510

(22) Filed: Jun. 17, 2002

(51) Int. Cl. B66F 7/12; B66F 7/28

(52) U.S. Cl. 187/213; 187/219

(57) ABSTRACT

A vehicle lift, a vehicle lift overhead assembly and a method for assembling a vehicle lift utilizes mounting configurations on each of the end of a cross member of the overhead assembly and a bracket for attachment to the upright column of the lift, with at least one of the mounting configurations including a plurality of mounting patterns which allow the member to be attached to the column by the bracket at any of a plurality of orientations relative to the column. The plurality of mounting patterns may include holes, pins or any feature capable of cooperation with complementarily shaped features to orient and secure together the components of the overhead assembly, such as slots, clamps and other similarly functioning structures.

### BACKGROUND OF THE INVENTION

The present invention relates to vehicle lifts having a cross member disposed between two upright columns, and more particularly to a vehicle lift in which the cross member may be oriented at a plurality of orientations with respect to the upright columns. The invention will be specifically disclosed in conjunction with a vehicle lift overhead assembly comprising a cross member and a pair of brackets which cooperate together to provide a plurality of orientations between the cross member and the upright columns to which the brackets are attached.

Symmetrical and asymmetrical two post vehicle lifts are well known, and comprise similar components, including two spaced apart upright columns and a cross member extending between the columns, typically from the top ends of each column. The cross member typically houses cables running between the two columns for synchronizing the movement of the vehicle lift superstructures carried by the columns, while providing support between the columns.

The columns of a symmetrical lift directly face each other, while the columns of an asymmetrical lift are disposed at an angle relative to each other. At each end of the cross member there are generally flat, vertically oriented mounting plates for connection to the upper ends of each column. For the symmetrical lift, since the facing surfaces of the upper ends of the columns are generally flat and perpendicular to the cross member, the mounting plates are perpendicular to the length of the cross member. For the asymmetrical, since the flat surfaces of the upper ends of the columns are angled relative to each other, the mounting plates are not perpendicular to the length of the cross member.

This difference in orientation of the columns between the symmetrical and asymmetrical lifts necessitates different cross members for each. For cross members which are made of a left and right member, the ends of each member are not symmetrical, the mounting plates being at opposite angles relative to the length of the respective member. This requires the symmetrical and asymmetrical lifts to each have their own unique left and right members. This can result in errors during assembly, such as when the wrong overhead is shipped with the lift. It also requires the manufacture of the unique parts.

Additionally, the use of a vertical mounting plate depending from the cross member makes installation a two person job, since the overhead will not support itself without being bolted to the column. A person must be at each column to put the bolts in at the same time.

An overhead assembly constructed in accordance with the present invention allows the same cross member and same brackets to be used on symmetrical and asymmetrical columns. It also allows a single person to install the cross member. Although the embodiments described herein are in conjunction with a two post vehicle lift, the present invention, as described and as claimed, is not limited to two post vehicle lifts, but may be used on any lifts having overhead assemblies, and regardless of whether the cross members are required to be capable of orientation at a plurality of orientations.

As defined by the Automotive Lift Institute ALI ALCTV-1998 standards, the types of vehicle lift superstructures include frame engaging type, axle engaging type, roll on/drive on type and fork type. As used herein, vertically moveable superstructure includes all vehicle lifting interfaces between the lifting apparatus and the vehicle, of any configuration now known or later developed.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a plan view of a symmetrical two post vehicle lift including an overhead assembly constructed in accordance with the teachings of the present invention.

FIG. 2 is a plan view of an asymmetric two post vehicle lift including an overhead assembly constructed in accordance with the teachings of the present invention.

FIG. 3 is a bottom perspective view of one end of a prior art overhead assembly.

FIG. 4 is a bottom perspective view of one end of an embodiment of an overhead assembly constructed in accordance with the teachings of the present invention.

FIGS. 5, 6 and 7 are bottom views of the overhead assembly embodiment of FIG. 4 with the bracket in various orientations.

FIG. 8 is a view of another embodiment of an overhead assembly constructed in accordance with the teachings of the present invention.

FIG. 9 is a view of another embodiment of an overhead assembly constructed in accordance with the teachings of the present invention.

FIG. 10 is a view of another embodiment of an overhead assembly constructed in accordance with the teachings of the present invention.

Reference will now be made in detail to the present preferred embodiment of the invention, an example of which is illustrated in the accompanying drawings.

### DETAILED DESCRIPTION

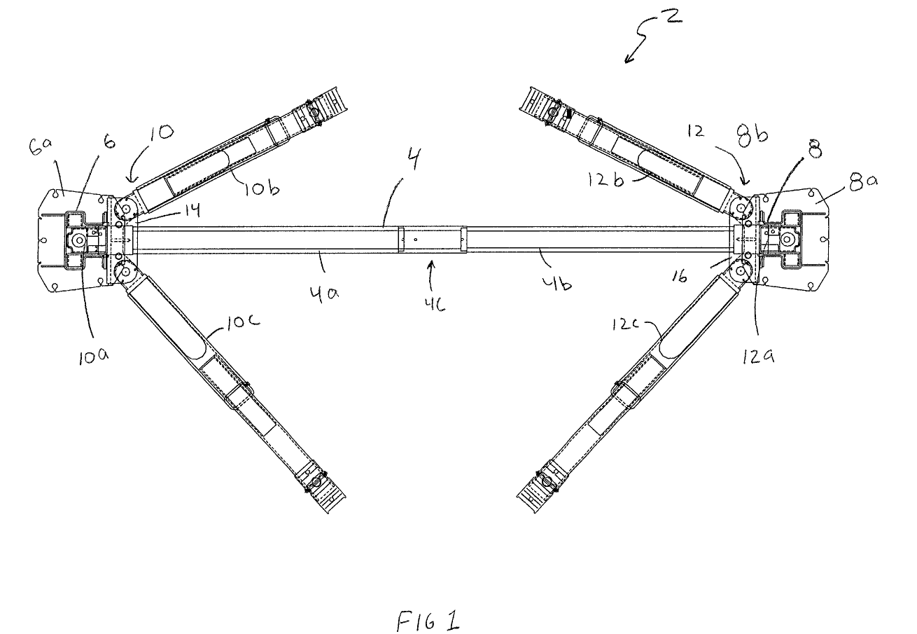

Referring now to the drawings in detail, wherein like numerals indicate the same elements throughout the views, FIG. 1 is a perspective view of a symmetrical two post vehicle lift generally indicated at 2. Lift 2 includes overhead member 4 disposed between a pair of spaced apart upright columns 6 and 8. Each column 6, 8 is attached to a respective base 6a, 8a which is secured to the floor in a manner well known in the industry. Columns 6 and 8 may include a column extension at the top thereof. As used herein, column includes a single piece column, a multiple piece column, a column and column extension. The column may have any suitable cross sectional shape.

Each column 6, 8, carries a respective vertically moveable superstructure 10, 12. Referring to vertically moveable superstructure 10, which is essentially a mirror image of vertically moveable superstructure 12, vertically moveable carriage 10a is carried by column 6, with arms 10b and 10c attached thereto.

Overhead member 4 comprises two members, 4a and 4b, connected to each at 4c. Overhead member 4 may be one piece. One end of each member 4a, 4b is connected to a respective bracket 14 and 16, as will be described below. Each bracket is connected to the upper end of a respective column 6, 8.

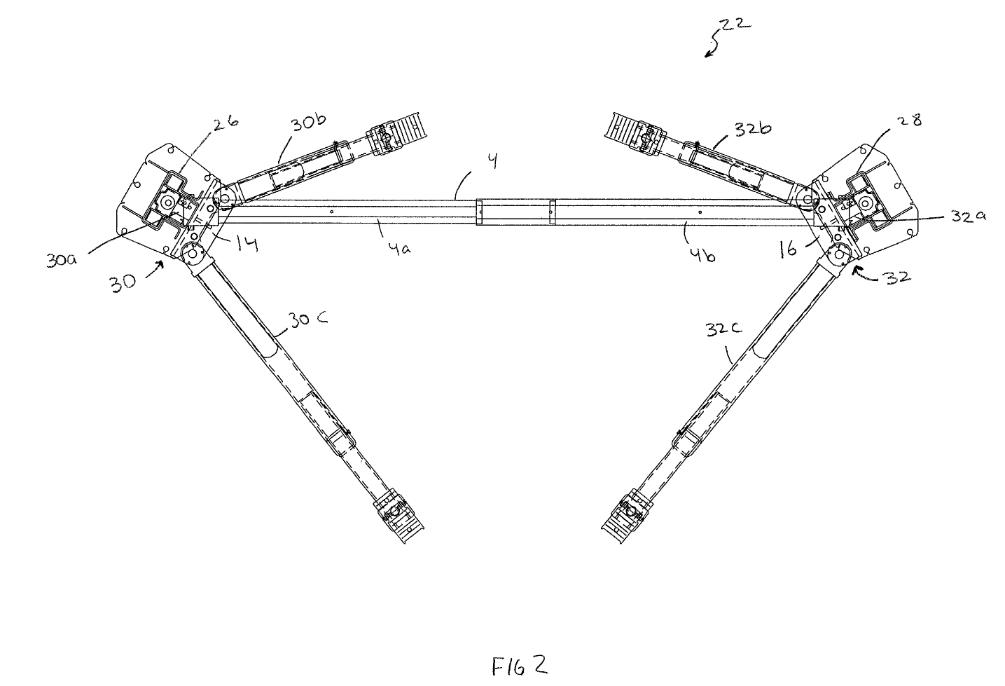

FIG. 2 is a perspective view of an asymmetric two post vehicle lift generally indicated at 22. The components of lift 22 are similar to lift 2, except columns 26 and 28 are disposed at an angle to each other to accommodate the asymmetric orientation of arms 30b, 30c, 32b, 32c. Cross member 4 and brackets 14 and 16 are identical for lifts 2 and 22.

FIG. 3 illustrates one end of a prior art overhead assembly 40 for an asymmetrical lift. Mounting plate 42 is welded to one end 44 of cross member 46. Plate 42 is oriented at an angle to the longitudinal axis of cross member 46. The longitudinal axis is parallel to a straight line between the spaced apart upright columns. The angle of plate 42 matches the angle of the upright columns in an asymmetric lift, allowing cross member 46 to be attached to each upper end of the cross members (not shown in FIG. 3). Plate 42 includes four holes 48 for securing plate and cross member 46 to the upright column. For a symmetrical lift, the mounting plate in a prior art overhead assembly is welded to the end of the cross member, perpendicular to the longitudinal axis of the cross member.

FIG. 4 illustrates one end of an embodiment of an overhead assembly constructed in accordance with the teachings of the present invention, such as used in lift 22 of FIG. 1. First end 38 of member 4b attached to bracket 16 by bolts 50. As seen in FIG. 4, bracket 16 is oriented at an angle relative to the longitudinal axis of member 4b, as for an asymmetric lift. Bracket 16 comprises two flat portions 16a and 16b disposed approximately perpendicular to each other. Portion 16a is illustrated generally as a horizontal flat shelf extending from portion 16b, illustrated as a generally vertical flat mounting plate. The configurations of portions 16a and 16b are shaped complementarily to the end of the cross member and upright column to which they respectively attach.

Bracket 16 is illustrated as being bolted to column extension 6b. Bracket 16 may be attached to column 6 (or column extension 6b) in any suitable manner, either as a separable piece such as by bolting, or integral to column 6 (or column 6b) such as by welding or as an integrally formed part thereof. Reference herein to a bracket being configured for attachment to a column includes being configured for attachment for a column extension as well as being integrally attached to or formed as part of a column or column extension.

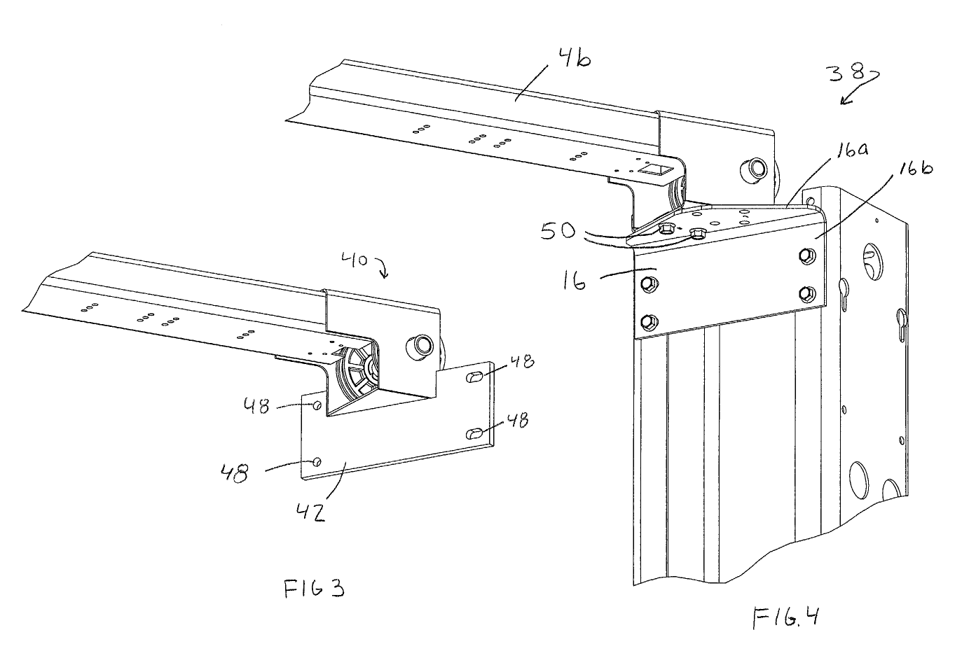

Referring to FIGS. 5, 6 and 7, there is shown a bottom view of the overhead assembly of FIG. 4, illustrating the plurality of orientations at which bracket 16 may be oriented relative to member 4b, such that member 4b may be attached to the upright column (not shown) at a plurality of orientations relative to the upright column by bracket 16.

In the depicted embodiment, end 52 of member 4b includes a mounting configuration which comprises a single mounting pattern of two spaced apart holes which receive bolts 50. Bracket 16 includes a mounting configuration which comprises a plurality of mounting patterns 54, 56 and 58 which are configured to selectively cooperate with the mounting configuration of end 52. Each mounting pattern in the depicted embodiment comprises a plurality of holes. Mounting pattern 54 comprises holes 54a and 54b. Mounting pattern 56 comprises holes 56a and 56b. Mounting pattern 58 comprises holes 58a and 58b. Member 4b may be oriented relative to bracket 16 at a selected angle such that one of mounting patterns 54, 56 and 58 align to cooperate with the holes if end 52 of member 4b.

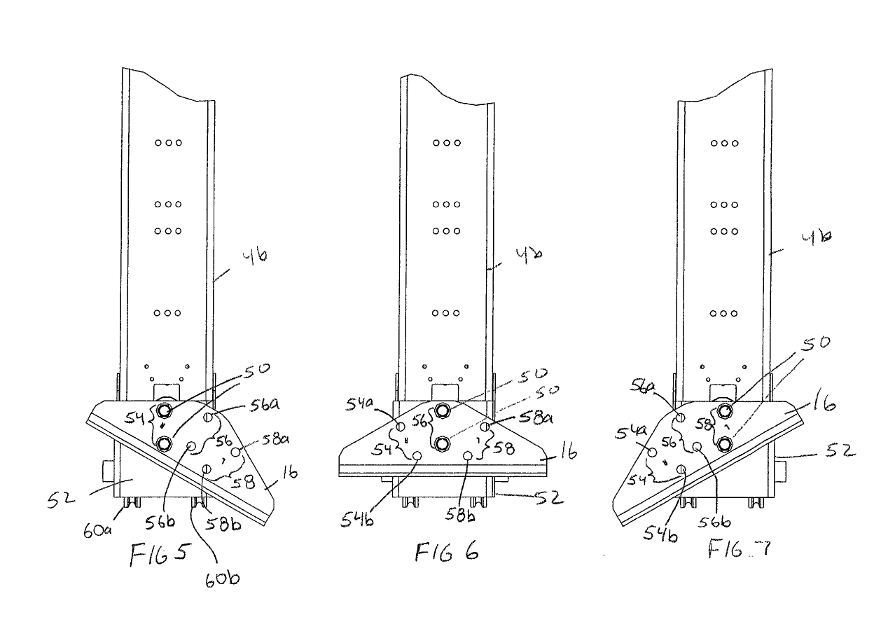

The vehicle lift overhead assembly shown in FIGS. 5, 6 and 6 allows a single bracket 16 to be used for both ends of cross member 4 whether for asymmetric lift 22 or symmetrical lift 2. Preferably, the cooperation between the mounting configurations of bracket 16 and end 52 locates end 52 in the proper position relative to the upright column to align components carried by cross member 4, such as pulleys 60a and 60b, with the upright column, regardless of the orientation of bracket 16 relative to cross member 4.

The vehicle lift overhead assembly shown in FIGS. 5, 6 and 6 allows cross member 4 to be connected to the upright columns by one person. First and second brackets 16 are attached to respective spaced apart upright columns, preferably adjacent the upper ends. A first end of cross member 4 is supported on the extending portion 16a of the first bracket 16, which acts as a shelf, without necessarily being secured thereto, while the other end of cross member 4 is attached to the second bracket 16. After the other end has been attached, the first end of the cross member is attached to the first bracket 16. The upright columns will have first been secured to the floor in an orientation such that the mounting configuration on each end of cross member 4 aligns and cooperates with a mounting configuration of brackets 16.

FIG. 8 is a view of another embodiment of an overhead assembly constructed in accordance with the teachings of the present invention. FIG. 8 is a bottom view of member 70 and a top view of bracket 62 so that the corresponding mounting configurations of each may be clearly seen. In this embodiment, bracket 62 includes mounting configuration 64 which comprises a single mounting pattern 66. Mounting pattern 66 comprises holes 66a and 66b. In this embodiment, end 68 of member 70 includes mounting configuration 72 which comprises a plurality of mounting patterns 74, 76 and 78. Each mounting pattern in the depicted embodiment comprises a plurality of holes. Mounting pattern 74 comprises holes 74a and 74b. Mounting pattern 76 comprises holes 76a and 76b. Mounting pattern 78 comprises holes 78a and 78b.

As can be seen, in both embodiments of FIGS. 5, 6 and 7 and FIG. 8, both the bracket and one end of the cross member include a mounting configuration. In the embodiment of FIGS. 5, 6, and 7, the cross member end mounting configuration includes one mounting pattern and the bracket mounting configuration includes a plurality of mounting patterns. In the embodiment of FIG. 8, it is the bracket mounting configuration that includes a single mounting pattern, and the cross member end mounting configuration that includes a plurality of mounting patterns. Thus, within the teaching of this invention, at least one of the mounting configurations of the bracket and the first end of the member comprises a plurality of mounting patterns.

Although, in both the embodiments of FIGS. 5, 6 and 7 and FIG. 8, each mounting pattern comprises its own unique plurality of holes, the mounting patterns of a single mounting configuration can share a common hole or feature. For example, in of FIGS. 5, 6 and 7, holes 54b and 58b can be disposed so that hole 56b comprises the second hole of mounting patterns 54 and 58, as well as 56, with the mounting pattern of end 52 being appropriately configured. Also by example, in FIG. 8, holes 74b and 78b can be disposed so that hole 76b comprises the second hole of mounting patterns 74 and 78, as well as 76, with the mounting pattern of bracket 62 being appropriately configured.

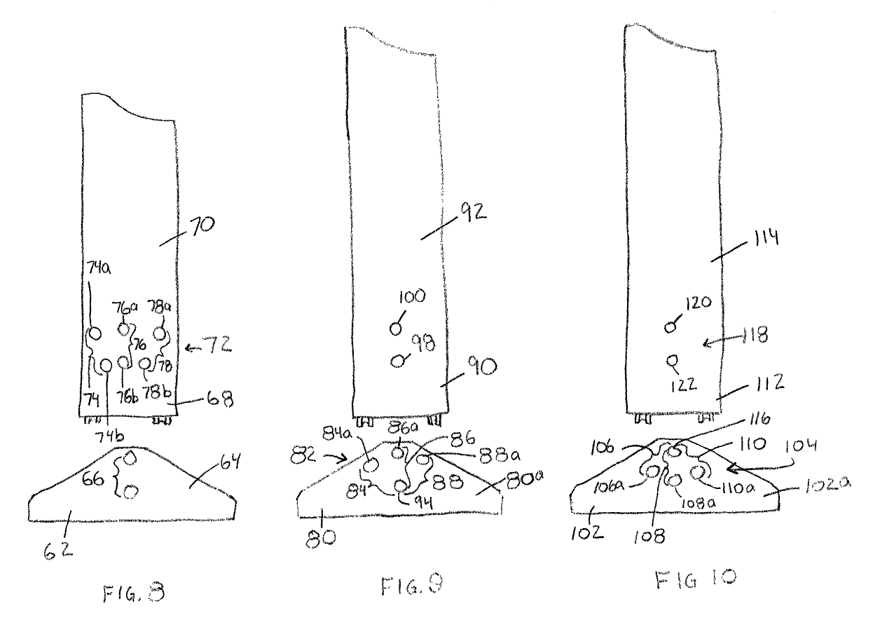

Referring to FIG. 9, there is shown a view of another embodiment of an overhead assembly constructed in accordance with the teachings of the present invention. FIG. 9 is a bottom view of member 92 and a top view of bracket 80 so that the corresponding mounting configurations of each may be clearly seen. Bracket 80 includes mounting configuration 82 which comprises a plurality of mounting patterns 84, 86 and 88 which are configured to selectively cooperate with the mounting configuration of end 90 of cross member 92. Each mounting pattern 84, 86, 88 shares a common feature 94, such as a pin extending from portion 80a of bracket 80. Mounting position 84 comprises hole 84a and pin 94. Mounting position 86 comprises hole 86a and pin 94. Mounting position 86 thus comprises hole 86a and pin 94. Mounting configuration 96 of end 90 comprises hole 98 for receiving pin 94, and hole 100 for selective cooperation with hole 84a, hole 86a or hole 88a.

Alternatively, end 90 may include a pin in place of hole 98, with pin 94 on bracket 80 being replaced by a hole for receiving such a pin carried by end 90.

Referring to FIG. 10, there is shown a view of another embodiment of an overhead assembly constructed in accordance with the teachings of the present invention. FIG. 10 is a bottom view of member 114 and a top view of bracket 102 so that the corresponding mounting configurations of each may be clearly seen. Bracket 102 includes mounting configuration 104 which comprises a plurality of mounting patterns 106, 108 and 110 which are configured to selectively cooperate with the mounting configuration of end 112 of cross member 114. Each mounting pattern 106, 108 and 110 shares a common feature 116, such as a pin extending from portion 102a of bracket 102. Mounting position 106 comprises hole 106a and pin 116. Mounting position 108 comprises hole 108a and pin 116. Mounting position 110 thus comprises hole 110a and pin 116. Mounting configuration 118 of end 90 comprises hole 120 for receiving pin 116, and hole 122 for selective cooperation with hole 106a, hole 108a or hole 110a.

Alternatively, end 112 may include a pin in place of hole 120, with pin 116 on bracket 102 being replaced by a hole for receiving such a pin carried by end 112.

Although each mounting pattern in the depicted embodiments comprises only two holes or a hole and a pin, more than two holes, and more than one hole with a pin, may be used as part of any of the mounting patterns. Furthermore, the mounting patterns are not limited to holes used with bolts or pins, but include any feature capable of cooperation with complementarily shaped features to orient and secure together the components of the overhead assembly, such as slots, clamps and other similarly functioning structures. Additionally, mounting configuration as used herein is intended to be equally broad, also including any construction which allows the mounting of the cross member end to the bracket, again such as slots, clamps and other similarly functioning structures.

It is noted that the bracket may be of any shape suitable for the specific mounting configuration utilized and for providing the necessary support to the cross member.

In summary, numerous benefits have been described which result from employing the concepts of the invention. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

What is claimed is:

1. A vehicle lift overhead assembly comprising:
a. a member configured to be disposed between a pair of spaced apart first and second upright columns of a vehicle lift, said member having a first end and a second end, said first end having a mounting configuration; and
b. a first bracket configured for attachment to said first column, said first bracket having a mounting configuration, the mounting configuration of at least one of said first end of said member and said first bracket comprising a first plurality of mounting patterns, each of said first plurality of mounting patterns configured to selectively cooperate with the other mounting configuration.

2. The vehicle lift overhead assembly of claim 1, wherein each respective mounting pattern comprises a plurality of holes.

3. The vehicle lift overhead assembly of claim 2, wherein each respective mounting pattern comprises at least one common hole.

4. The vehicle lift overhead assembly of claim 2, wherein said other mounting configuration comprises a plurality of holes.

5. The vehicle lift overhead assembly of claim 2, wherein said other mounting configuration comprises at least one pin.

6. The vehicle lift overhead assembly of claim 5, wherein said other mounting configuration further comprises at least one hole.

7. The vehicle lift overhead assembly of claim 1, wherein each respective mounting pattern comprises at least one common pin.

8. The vehicle lift overhead assembly of claim 7, wherein each respective mounting pattern further comprises at least one hole.

9. The vehicle lift overhead assembly of claim 1, wherein said mounting configuration of said first bracket comprises said first plurality of mounting patterns.

10. The vehicle overhead assembly of claim 1, wherein said first bracket is integral to said first column.

11. The vehicle overhead assembly of claim 10, wherein said first bracket is welded to said first column.

12. The vehicle overhead assembly of claim 10, wherein said first bracket is formed integrally with said first column.

13. The vehicle lift overhead assembly of claim 1, further comprising:
a. said second end of said member having a mounting configuration; and
b. a second bracket configured for attachment to said second column, said second bracket having a mounting configuration, the mounting configuration of at least one of said second end of said member and said second bracket comprising a second plurality of mounting patterns, each of said second plurality of mounting patterns configured to selectively cooperate with the other mounting configuration.

13. The vehicle lift overhead assembly of claim 13, wherein said first and second bracket are interchangeable with each other.

15. The vehicle lift overhead assembly of claim 13, wherein second end has mirror image symmetry with said first end.

16. A vehicle lift comprising:
a. first and second spaced apart upright columns, said first having a first upper end, said second column having a second upper end;
b. a first vertically moveable superstructure carried by said first column, said first vertically moveable superstructure being vertically moveable along said first column;
c. a second vertically moveable superstructure carried by said second column, said second vertically moveable superstructure being vertically moveable along said second column;
d. a member disposed between said first and second columns, said member having a first end disposed adjacent said first upper end and a second end disposed adjacent said second upper end, said first end having a respective mounting configuration, said second end having a respective mounting configuration;
e. a first bracket attached to said first column, said first bracket having a mounting configuration, the mounting configuration of at least one of said first end of said member and said first bracket comprising a first plurality of mounting patterns, each of said first plurality of mounting patterns configured to selectively cooperate with the mounting configuration of the other of said first end of said member and said first bracket so as to allow said first column to be oriented at any of a plurality of orientations relative to said member; and
f. a second bracket attached to said second column, said second bracket having a mounting configuration, the mounting configuration of at least one of said second end of said member and said second bracket comprising a second plurality of mounting patterns, each of said second plurality of mounting patterns configured to selectively cooperate with the mounting configuration of the other of said second end of said member and said second bracket so as to allow said second column to be oriented at any of a plurality of orientations relative to said member.

16. The vehicle lift of claim 16, wherein each respective mounting pattern of at least one of said first plurality of mounting patterns and said second plurality of mounting patterns comprises a plurality of holes.

18. The vehicle lift of claim 17, wherein said plurality of holes comprises at least one hole common to each of said respective mounting patterns.

19. The vehicle lift of claim 16, wherein each respective mounting pattern of at least one of said first plurality of mounting patterns and said second plurality of mounting patterns comprises at least one pin common to each of said respective mounting patterns.

19. The vehicle lift of claim 16, wherein at least one of said mounting configurations comprises at least one hole.

21. The vehicle lift of claim 16, wherein at least one of said mounting configurations comprises at least one pin.

22. The vehicle lift of claim 16, wherein said first and second bracket are interchangeable with each other.

23. The vehicle lift of claim 16, wherein second end has mirror image symmetry with said first end.

24. The vehicle lift of claim 16 wherein said first bracket is integral to said first column.

25. The vehicle lift of claim 24, wherein said first bracket is welded to said first column.

26. The vehicle lift of claim 24, wherein said first bracket is formed integrally with said first column.

27. A method of assembling a vehicle lift having first and second spaced apart upright columns, said first column having a first upper end, said second column having a second upper end, comprising the steps of:
a. attaching a first bracket to said first column adjacent said first upper end;
b. attaching a second bracket to said second column adjacent said second upper end; and
c. attaching a member to said first and second brackets, said member having a first and second end, said attaching a member step the steps of:
i. supporting said first end with said first bracket;
ii. attaching said second end to said second bracket while said second end is supported by said first bracket; and
iii. attaching said first end to said first bracket.

28. The method of claim 27, further comprising the steps of:
a. providing a mounting configuration on said second bracket;
b. providing a mounting configuration on said second end;
c. providing the mounting configuration on at least one of said second end and said second bracket with a first plurality of mounting patterns, each of said first plurality of mounting patterns configured to selectively cooperate with the other mounting configuration so as to allow said second column to be oriented at any of a first plurality of orientations relative to said member;
c. orienting said second column at one of said first plurality of orientations prior to attaching said second end to said second bracket.

29. The method of claim 28, further comprising the steps of:
a. providing a mounting configuration on said first bracket;
b. providing a mounting configuration on said first end;
c. providing the mounting configuration on at least one of said first end and said first bracket with a second plurality of mounting patterns, each of said second plurality of mounting patterns configured to selectively cooperate with the other mounting configuration so as to allow said first column to be oriented at any of a second plurality of orientations relative to said member; and
d. orienting said first column at one of said second plurality of orientations prior to attaching said first end to said first bracket.

30. A vehicle lift overhead assembly comprising:
a. a member configured to be disposed between a pair of spaced apart first and second upright columns of a vehicle lift, said member having a first end and a second end, said first end having a mounting configuration; and
b. a first bracket attached to said first column, said first bracket having a mounting configuration, the mounting configuration of at least one of said first end of said member and said first bracket comprising a first plurality of mounting patterns, each of said first plurality of mounting patterns configured to selectively cooperate with the other mounting configuration.

31. The vehicle lift of claim 30 wherein said first bracket is integral to said first column.

32. The vehicle lift of claim 31, wherein said first bracket is welded to said first column.

33. The vehicle lift of claim 31, wherein said first bracket is formed integrally with said first column.
